(19) United States
(12) Patent Application Publication
(10) Pub. No.: US 2005/0286566 A1
(43) Pub. Date: Dec. 29, 2005

(54) Versatile erasure forecasting system for impulse noise mitigation

(76) Inventors: Po Tong, Los Altos, CA (US); Peter Liu, Alameda, CA (US)

Correspondence Address: TEXAS INSTRUMENTS INCORPORATED, P O BOX 655474, M/S 3999, DALLAS, TX, 75265, US

(21) Appl. No.: 11/159,476

(22) Filed: Jun. 23, 2005

Related U.S. Application Data
(60) Provisional application No. 60/582,738, filed on Jun. 23, 2004.

(51) Int. Cl. H04J 3/06

(52) U.S. Cl. 370/503

(57) ABSTRACT

The present invention provides a system for mitigating impulse noise effects in a digital data transmission system, particularly in a DSL-based communications system (300), by optimizing error correction systems with an erasure forecasting scheme. Within the communications system, encoding and structuring constructs form and permute data transmission units for transmission in a deterministic manner (i.e., having known, fixed characteristics). Once data transmission units have been received over a transmission channel, de-structuring and decoding constructs inversely permute and decode those data transmission units, according to the deterministic manner. Data decoding is monitored (302), and the occurrence of an impulse noise event in the transmission channel is identified (304). A first data transmission unit affected by the impulse noise event is decoded (306). A forecasting construct evaluates the decoded first data transmission unit using known characteristics of the deterministic manner (308, 310), and develops a forecast (312) of locations of an erasure error within a subsequent decoded data transmission unit, which is then utilized to optimize error correction.

### PRIORITY CLAIM

This application claims priority of U.S. Provisional Application No. 60/582,738, filed Jun. 23, 2004.

### TECHNICAL FIELD OF THE INVENTION

The present invention relates generally to the field of digital voice and data communications and, more particularly, to a versatile system, comprising various constructs and methods, for mitigating deleterious impulse noise effects on digital communications through erasure forecasting.

### BACKGROUND OF THE INVENTION

Increasing demand for more powerful and convenient data and information communication has spawned a number of advancements in communications technologies. One area of particular interest is broadband communication, and related applications. The growing usage of broadband communications has given rise to a number of manufacturing and operational considerations. Some of those considerations are unique to broadband, while others are common to most communications technologies. Amongst the common considerations for most modern communications technologies is the need or desire to maximize data transfer rates.

Since broadband communications rely on transmissions through a number of transmission media (e.g., optic fiber, wire), broadband systems may be subjected to a number of internal and external (e.g., environmental) interferences. Consider, for example, digital subscriber line (DSL) services. Commonly, such services are provided using telephone infrastructure. Data transmissions through such services may therefore be subjected to a number of electrical anomalies that can impede or corrupt data integrity. One such anomaly is impulse noise—which can be electrical noise, of varying and indeterminate duration or intensity, occurring in the communication channel that disrupts or corrupts data communications.

Impulse noise and other transmission anomalies are problematic for DSL and other similar broadband systems. They are even more problematic—and potentially catastrophic—for newer, high-speed technologies such as asymmetric DSL (ADSL) and very high speed DSL (VDSL). These and other yet-to-be-developed communications technologies transmit increasingly greater volumes of data in shorter amounts of time than conventional DSL. Whereas impulse noise of a given duration or magnitude may have introduced recoverable data errors into a slower, conventional DSL transmission—impulse noise of that same duration or magnitude could introduce substantial and potentially unrecoverable data errors into the much faster ADSL or VDSL transmissions.

Conventionally, communications systems rely on a variety of coding, multiplexing and error recovery schemes to reduce the negative impact of transmission anomalies. In some cases, such schemes are not mutually cooperative, or may even be incompatible. Commonly, many error recovery and coding schemes rely upon some level of data redundancy during transmission. A higher degree of data redundancy reduces a system's effective throughput. Thus, system design must make some tradeoff between acceptable data reliability levels and acceptable data throughput rates.

Moreover, a number of conventional error correction schemes view data corruption as a single component—making no distinction between transmission errors that have corrupted data, and those that have simply erased data. Often, conventional correction schemes replace or retransmit some fundamental transmission unit (e.g., byte, code word) in which an error occurs, rather than determining the relative magnitude or location of an error within that transmission unit. These systems do not make optimal use of data redundancy, as they often replace or retransmit data unnecessarily. Such schemes therefore have a greater reliance on data redundancy, and may thereby experience less-than-optimal data throughput rates.

As a result, there is a need for a system that addresses and minimizes the deleterious effects of impulse noise and other similar transmission anomalies in conventional and advanced broadband communications—particularly in ADSL and VDSL technologies—in a manner that compatible with incumbent coding, multiplexing and correction schemes while effectively optimizing data redundancy usage to balance acceptable data reliability levels and acceptable data throughput rates in a desired manner, while providing efficient and reliable communications in an easy, cost-effective manner.

### SUMMARY OF THE INVENTION

The present invention provides a versatile system, comprising various constructs and methods, for mitigating deleterious impulse noise effects on digital communications, particularly conventional and advanced broadband communications (e.g., ADSL, VDSL). The present invention provides a versatile system that is compatible with a wide variety of coding, multiplexing and correction schemes. The system of the present invention effectively optimizes data redundancy, to balance acceptable data reliability levels and acceptable data throughput rates in a desired manner.

Specifically, the system of the present invention provides an erasure forecast scheme that comprehends both data errors and data erasures due to impulse noise effects. The system of the present invention provides constructs that—based on known characteristics of transmission-side elements (e.g., interleaver, multiplexing)—analyzes received data transmissions to determine if incoming transmission errors are data erasures and, if so, to forecast the location of such erasures. The system of the present invention factors this result into a determination of redundancy allocation, providing a control mechanism through which data reliability and data throughput may be optimized or balanced in a desired manner.

More specifically, embodiments of the present invention provide system, methods and constructs for mitigating impulse noise effects in a digital data transmission system—particularly in an advanced DSL-based communications system—by optimizing error correction with an erasure forecasting scheme. Within the communications system (e.g., ADSL, VDSL), encoding and structuring constructs form and permute data transmission units for transmission in a deterministic manner (i.e., having known, fixed characteristics). Once data transmission units have been received over a transmission channel, de-structuring and decoding constructs inversely permute and decode those data transmission units, according to the deterministic manner. Data decoding is monitored, and the occurrence of an impulse noise event in the transmission channel is identified. A first data transmission unit affected by the impulse noise event is decoded. A forecasting construct evaluates the decoded first data transmission unit, using the known characteristics of the deterministic manner. From that evaluation, the forecasting construct develops a forecast of location(s) of an erasure error within a subsequent decoded data transmission unit. This forecast is then utilized in cooperation with incumbent decoding to optimize error correction.

Other features and advantages of the present invention will be apparent to those of ordinary skill in the art upon reference to the following detailed description taken in conjunction with the accompanying drawings.

### BRIEF DESCRIPTION OF THE DRAWINGS

For a better understanding of the invention, and to show by way of example how the same may be carried into effect, reference is now made to the detailed description of the invention along with the accompanying figures in which corresponding numerals in the different figures refer to corresponding parts and in which:

FIG. 1 provides an illustration depicting an embodiment of a digital communication system;

FIG. 2 provides an illustration depicting evaluation of data transmission units in accordance with certain aspects of the present invention; and

FIG. 3 provides an illustration depicting an embodiment of a system implementing certain aspects of the present invention.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The present invention is hereafter illustratively described primarily in conjunction with the design and operation of a high-performance DSL (e.g., ADSL, VDSL) communications system. Certain aspects of the present invention are further detailed in relation to specific multiplexing and coding techniques. Although described in relation to such constructs and schemes, the teachings and embodiments of the present invention may be beneficially implemented with a variety of broadband and other digital communications technologies. The specific embodiments discussed herein are, therefore, merely demonstrative of specific ways to make and use the invention and do not limit the scope of the invention.

The present invention provides a versatile system of constructs and methods for mitigating deleterious impulse noise effects on digital communications systems, particularly conventional and advanced broadband communications (e.g., ADSL, VDSL). The system of the present invention is compatible with a wide variety of coding, multiplexing and correction schemes. The present invention provides a system that may be utilized to effectively optimize data redundancy—and thereby balance acceptable data reliability levels and acceptable data throughput rates in a desired manner.

Embodiments of the present invention provide a system for mitigating impulse noise effects in a digital data transmission system by optimizing error correction with an erasure forecasting scheme. Within the communications system encoding and structuring constructs form and permute data transmission units for transmission in a deterministic manner (i.e., having known, fixed characteristics). Once data transmission units have been received over a transmission channel, de-structuring and decoding constructs inversely permute and decode those data transmission units, according to the deterministic manner. Data decoding is monitored, and the occurrence of an impulse noise event in the transmission channel is identified. A first data transmission unit affected by the impulse noise event is decoded using the decoding scheme incumbent within the communications system. A forecasting construct then evaluates that decoded first data transmission unit, particularly in light of the known characteristics of the deterministic manner. From that evaluation, the forecasting construct develops a forecast of location(s) of erasure error(s) within a subsequent decoded data transmission unit. This forecast is then utilized in cooperation with incumbent decoding to optimize error correction as desired.

Specifically, the system of the present invention provides an erasure forecast scheme that comprehends both data errors and data erasures due to impulse noise and other noise effects. The system of the present invention provides constructs that—based upon known characteristics of a system's transmission-side elements (e.g., interleaver, multiplexing)—analyzes received data transmissions to determine if incoming transmission errors are data erasures and, if so, to forecast the location of such erasures. The system of the present invention factors this result into a determination of redundancy allocation, providing a control mechanism through which data reliability and data throughput may be optimized or balanced in a desired manner.

The present invention provides a robust evaluation scheme that further comprehends and provides the ability to evaluate the validity of data experiencing impulse noise. Rather than completely discard all data transmitted during an impulse noise event, the present invention provides a metric by which the extent of valid or invalid data transmitted during the event may be characterized. That metric may then be compared to some desired threshold, above which or below which different data processing assumptions may be made for convenience and efficiency. For example, if the metric indicates an invalidity ratio above a desired threshold, then the system of the present invention may be adapted to function under the assumption that all data—within some relatively large transmission unit (e.g., code word)—transmitted during an impulse noise event is invalid. If, however, the metric indicates an invalidity ratio below a desired threshold, then the system of the present invention may be adapted to parse or evaluate the validity of some much smaller transmission unit (e.g., byte). This aspect of the present invention provides yet another utility through which the balance between data reliability and data throughput may be optimized in a desired manner.

For purposes of explanation and illustration, certain aspects of the present invention are now described in relation to relatively limited illustrative embodiments where an assumption is made that most or all data within a relatively large transmission unit (e.g., code word) transmitted during an impulse noise event is invalid. After certain aspects of the present invention are illustrated in relation to this relatively limited example, other aspects of the present invention will thereafter be described in relation to a more general application of the present invention that comprehends other assumptions.

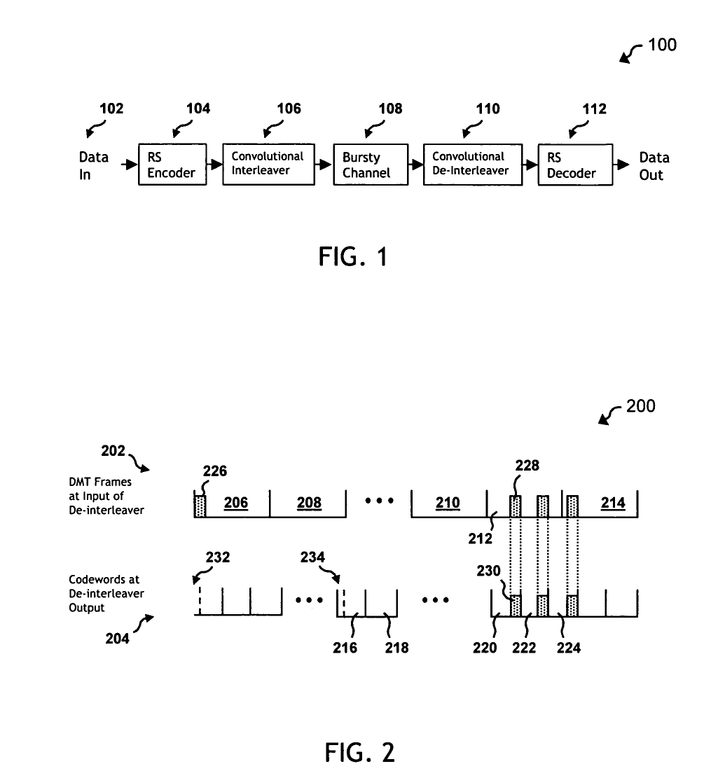

Referring now to FIG. 1, a sample DSL communications system 100 is illustratively depicted. System 100 may comprise either an ADSL or VDSL system, for the purposes of illustration and explanation. System 100 comprises some data input 102. That data is delivered for processing by some encoding function 104. For purposes of illustration and explanation, function 104 is a Reed-Solomon (RS) encoder. Data is then passed to some structuring function 106—a convolutional interleaver in this embodiment. That data is then transmitted over some transmission channel 108, which may be subject to burst noise or some other impulse noise event. After reception through channel 108, data is then processed by a de-structuring function 110—a convolutional de-interleaver in this instance. The data is next processed by a decoding function 112—a RS decoder function. System 100 reflects the fact that in applicable ADSL/VDSL standards, convolutional interleaving is frequently used in conjunction with RS coding to mitigate impulse noise or burst errors that occur in the transmission channel.

In this embodiment, system 100 comprises an interleaver 106 and a de-interleaver (or inverse interleaver) 110, situated on opposite ends of channel 108. Channel 108 may include an inner coding scheme, in addition to the physical transmission channel, in a concatenated coding scheme. Interleaver 106 structures, organizes or otherwise permutes the ordering of a sequence of data symbols in a deterministic manner, while de-interleaver 110 applies the inverse permutation to restore the sequence of data symbols to its original ordering, except for a fixed delay.

A convolutional interleaver in applicable ADSL/VDSL standards may be specified by a sequence of n interleaver delays [i(d−1), i=0,1, . . . , n−1] for the n symbols in RS codeword of length n; where i is the index of the location of a symbol within a given codeword, and d is the depth of the interleaver. The values of n and d should be co-prime, to ensure that no two symbols will occupy the same time slot at the output of the interleaver. The convolutional interleaver spreads out RS symbols such that two adjacent symbols at the input to the interleaver are always exactly d symbols apart in the channel 108 (i.e. the output of the interleaver).

As a result, a burst of length d symbols long in the channel will affect d RS codewords, with only a single error per RS codeword. A RS code, having R redundant symbols, is capable of correcting [R/2] errors. Thus, system 100 is capable of correcting errors from a burst whose length does not exceed [R/2] d symbols. According to the present invention, however, the maximum length of a correctable burst is extended beyond [R/2] d symbols, by exploiting combinatorial properties of convolutional interleaving and by exploiting erasure-decoding aspects of RS codes.

An RS code with R redundant symbols is capable of correcting s data erasures and t data errors, so long as: s+2t≦R. Thus, compared with data errors, data erasures are half as complex or costly to correct. Comprehending this, a system that reliably forecasts erasures may be provided with more optimal burst correcting capability than that of the above system.

According to the present invention, erasures for a current codeword are forecast by using certain analyses of a previously decoded codeword. The combinatorial properties of convolutional interleaving ensure that even with a very long noise burst, the first codeword affected by the noise will have a relatively small number of errors. As a result, basic decoding error correction techniques may be used to successfully decode the first affected codeword. Once the first affected codeword has been successfully decoded, then forecasting according to the present invention may be properly initiated, providing for subsequent and more complicated decoding.

Certain aspects of the present invention may be more easily understood by way of an illustrative example. For this example, n=8, d=5, and R=6, and Table 1, below, applies. Each field in Table 1 has 3 entries. The first entry of each field indicates a codeword number. Table 1 thus indicates that codewords 0 and 5 occupy its first column. Codewords 1 and 6 occupy its fourth column, and so on. The second entry of each field indicates a time slot when an associated RS symbol enters the interleaver. The third entry in each field indicates a time slot when an associated RS symbol exits the interleaver. If Table 1 is traversed horizontally, from left to right, row by row, the third entries in the table form a counting sequence. This table can be regarded as an effectively infinite memory—where inputs to the interleaver are written in columns, and outputs of the interleaver are taken out from left to right, in a row-by-row manner.

TABLE 1

| | | | | |
|---|---|---|---|---|
| 0, 0, 0 | | | | |
| 0, 1, 5 | | | 1, 8, 8 | |
| 0, 2, 10 | | | 1, 9, 13 | |
| 0, 3, 15 | 2, 16, 16 | | 1, 10, 18 | |
| 0, 4, 20 | 2, 17, 21 | | 1, 11, 23 | 3, 24, 24 |
| 0, 5, 25 | 2, 18, 26 | | 1, 12, 28 | 3, 25, 29 |
| 0, 6, 30 | 2, 19, 31 | 4, 32, 32 | 1, 13, 33 | 3, 26, 34 |
| 0, 7, 35 | 2, 20, 36 | 4, 33, 37 | 1, 14, 38 | 3, 27, 39 |
| 5, 40, 40 | 2, 21, 41 | 4, 34, 42 | 1, 15, 43 | 3, 28, 44 |
| 5, 41, 45 | 2, 22, 46 | 4, 35, 47 | 6, 48, 48 | 3, 29, 49 |
| 5, 42, 50 | 2, 23, 51 | 4, 36, 52 | 6, 49, 53 | 3, 30, 54 |
| 5, 43, 55 | | 4, 37, 57 | 6, 50, 58 | 3, 31, 59 |
| 5, 44, 60 | | 4, 38, 62 | 6, 51, 63 | |
| 5, 45, 65 | | 4, 39, 67 | 6, 52, 68 | |
| 5, 46, 70 | | | 6, 53, 73 | |
| 5, 47, 75 | | | 6, 54, 78 | |
| | | | 6, 55, 83 | |

For the example illustrated by Table 1, consecutive codewords do not necessarily occupy consecutive columns. In fact, the difference in columns for consecutive codewords is equal to n mod d. Using the sample values of n=8 and d=5, this value is 3. Within the channel, a symbol in a subsequent codeword, following a symbol with location i in the current codeword, has location i−[n div d]. In our current example, this value is i−1. This relationship holds as long as i≧[n div d]. For ease of reference, a symbol with location i−[n div d] in the next codeword, will be referred to as successor of the symbol with location i in the current codeword.

Consider, for example, a noise burst over the channel having a length of 20 symbols, starting at time slot 28. These 20 symbols are highlighted with bold borders in Table 1. With a give redundancy of R=6 symbols, a conventional error-only decoding strategy fails to correct this burst error, since each of codewords 1, 2, 3 and 4 has 4 errors. In contrast, the erasure forecasting scheme of the present invention successfully corrects this burst error.

In accordance with the erasure forecasting scheme of the present invention, symbols in a codeword can be classified into 3 categories after the codeword has been successfully decoded. Good symbols are symbols that were not erased, and determined to be good using the decoder. Corrected symbols are symbols that may or may not be erased. Corrected symbols determined to be bad and corrected using the decoder. Falsely erased symbols—which may also be referred to as false erasures—are symbols that were erased, but determined to be good using the decoder. In the case of false erasures, the value of the erased symbol, as computed by the RS decoder, matches the value of received symbol at the input to the RS decoder.

According to certain aspects of the present invention, one simple erasure forecasting scheme comprises erasing all successors—within the next codeword—of corrected symbols within a current codeword. If decoding of the current codeword is not successful (e.g., the received codeword is determined to be un-decodable due to an uncorrectable volume of errors), then no symbols in the next codeword are erased.

Again, certain aspects of the present invention may be more easily understood by way of an illustrative example. For this example, Table 2, below, summarizes an outcome of this simple erasure forecasting scheme. Table 2 illustrates an outcome of combining this approach with RS decoding, where R=6 redundant symbols, and applying that combination to the 20-symbol burst starting at time slot 28 example. Table 2 indicates that s+2t never exceeds R. As a result, all 7 codewords affected by a burst may be successfully decoded using an erasure forecasting algorithm.

TABLE 2

| | Codeword | | | | | | |
|---|---|---|---|---|---|---|---|
| | 0 | 1 | 2 | 3 | 4 | 5 | 6 |
| Location of Symbols in | 6, 7 | 4, 5, 6, 7 | 3, 4, 5, 6 | 1, 2, 3, 4 | 0, 1, 2, 3 | 0, 1 | None |
| Burst | | | | | | | |
| Successors of Corrected | None | 5, 6 | 3, 4, 5, 6 | 2, 3, 4, 5 | 0, 1, 2, 3 | 0, 1, 2 | 0 |
| Symbols in Previous | | | | | | | |
| Codeword (Erased | | | | | | | |
| Symbol Locations) | | | | | | | |
| Number of Erasures s | 0 | 2 | 4 | 4 | 4 | 3 | 1 |
| Number of Errors t | 2 | 2 | 0 | 1 | 0 | 0 | 0 |
| s + 2t | 2 | 6 | 4 | 6 | 4 | 3 | 1 |
| R | 6 | 6 | 6 | 6 | 6 | 6 | 6 |
| Locations of Falsely | None | None | None | 5 | None | 2 | 1 |
| Erased | | | | | | | |
| Symbols | | | | | | | |

The second row of Table 2 indicates location of symbols affected by a burst. The error-affected locations of a first codeword are situated towards the end of that codeword, and the total number of such locations is typically small. As Table 2 progresses across from codeword to codeword, locations within an affected codeword move towards the center of that codeword—and then eventually reach the beginning. In correspondence to this progression, the number of such locations increases initially, then becomes stable, and eventually decreases, until the noise burst ends. The last row of Table 2 lists falsely erased symbols, which generally tend to occur towards the later part of a noise burst.

Within this scheme, it is possible that a symbol affected by a burst still has a chance of being good just by accident. Generally, the probability of such an occurrence is approximately 2^{-m}; where m is the number of bits per symbol. Such an occurrence may inadvertently lead to a false erasure, which may affect the burst correction capability of this scheme. The system of the present invention comprehends and resolves this issue, however, as described hereinafter.

Having illustrated the successor property using one example, that property is now more generally developed and described. That successor property may be expressed as follows. Let n be a code length, and d be an interleaving depth for a convolutional interleaver—i.e., interleaving delay for a symbol at location i is i(d−1), for i=0, 1, . . . , n−1. At the output of the interleaver, suppose a symbol belongs to codeword j and has a symbol location i. The next occurrence of the symbol at codeword j+1 has a symbol location i−[n div d], provided that i≧[n div d]. The symbol at location i−[n div d] of codeword j+1 is referred to as the successor of the symbol at location i of codeword j.

The symbol with location i for codeword j occupies a time slot jn+i at the input to the interleaver. Delay through the interleaver for this symbol is i(d−1), thus it occupies time slot jn+id at the output of the interleaver. A successor may be defined by the smallest integer k such that (j+1)n+kd>jn+id. It may be directly verified that i−[n div d] is such an integer, provided that i≧[n div d].

In other embodiments of the present invention, a more robust erasure forecasting system is provided. In such embodiments, n is a code length, d is an interleaving depth for a convolutional interleaver, and R is the number of redundant symbols per RS codeword. A function h(n, d) is provided, having a value of [n div d] if d<n, and 1 otherwise. Where this erasure forecasting scheme erases—in subsequent codewords—all successors of corrected symbols in current codewords, a burst of length B=(R−h(n, d)−1)d consecutive bad symbols received from the channel can be corrected successfully, if R/2>h(n, d)+1. This erasure forecasting scheme is particularly useful where R is relatively large, compared to [n div d]. It may be directly verified that R/2>h(n, d)+1 implies that (R−h(n, d)−1)>R/2. As a result, this scheme provides superior burst error correction capability when compared with an error-only decoding algorithm.

A burst of length B symbols affects m consecutive codewords at the input to the interleaver. If Lᵢ (i=1, 2, . . . , m) denotes a set of contiguous locations for the i^{th} codeword affected by the burst, and there exist integers p and q, where 1<p≦q<m, then the following properties may be provided:
0<|L₁|≦|L₂|≦ . . . ≦|Lₚ|= . . . =|L_{q}|≧|L_{q+1}|≧|L_{q+2}|≧ . . . ≧|Lₘ|>0; (1)
or, stated another way, the number of locations affected increases, becomes stable, and eventually decreases;
|L₁|≦[n div d]+1, and |Lₚ=(R−h(n, d)−1); (2)
for i=1, 2, . . . , p−1; Succ(Lᵢ)⊂Lᵢ₊₁ and |Lᵢ₊₁|−|Lᵢ|≦[n div d]+1; (3)
or, stated another way, for each codeword i of a first group of p−1 codewords, all erased locations in the next codeword (codeword i+1) are bad, and the number of bad locations not erased is, at most, [n div d]+1;
for i=p, p+1, . . . , q−1; (4)
a. Succ(Lᵢ)=Lᵢ₊₁; or
b. Lᵢ₊₁=Succ(Lᵢ)/{last location of Succ(Lᵢ)}∪{first location of Lᵢ₊₁};
   or, stated another way, for each codeword i of this second group of q−p codewords, the set of bad locations in the next codeword (i.e., codeword i+1) either exactly coincides with the set of erased symbols, or they are offset from each other by one symbol;
   for i=q, q+1, . . . , m, Succ(Lᵢ)⊃Lᵢ₊₁; (5)
   or, stated another way, for each codeword i of this third group of m−(q+1) codewords, all bad locations are erased. There is at most one falsely erased symbol.

Given the above properties, and conditions described thus far, and |L₁|≧[n div d]+1≦/R2 (by property (2) and the condition R/2>h(n, d)+1), the first affected codeword with no symbols erased may be decoded. As previously indicated, this enables the commencement of the erasure forecasting algorithm.

The above-described algorithm may be verified by analyzing several factors. First, it may be useful to introduce or define certain terms. Let n be the codeword length and d be the depth of a convolutional interleaver—where n and d are co-prime. Let Z be the set of integers, and define a function ƒ: Z×Z→Z by ƒ(j, i)=jn+id. Function ƒ is a subjective homomorphism from the group Z×Z to the group Z. The subgroup K={(kd, −kn): kεZ} of Z×Z is the kernel of function ƒ (i.e., ƒ(j, i)=0 if (j, i) is in K). Function ƒ induces a group isomorphism g: Z×Z/K→Z, where Z×Z/K denotes a set of partitions when Z×Z is partitioned into equivalent classes, determined by the equivalence relationship (˜). The equivalence relationship is defined by (x˜y), if (x˜y)εK for all (x, y)εZ×Z. The notation <j, i> denotes an equivalent class whose representative is (j, i)εZ×Z. Thus, <j, i>={(j+kd, i−kn): kεZ}. In each equivalent class <j, i>, there is a unique representation with property 0≦i<n. In the case where 0≦i<n, (j, i) is referred to as a canonical representative, and <j, i> as a canonical representation. Thus, generally, for any <j, i>εZ×Z/K, its canonical representative is (j+[i div n]d, i−[i div n]n)=(j+[i div n]d, i mod n).

A symbol at location i of codeword j is input to an interleaver at time slot jn+i. With a delay of i(d−1) through the interleaver, that symbol is output from the interleaver at time slot jn+id. A function g maps from a codeword's symbol to its output time slots. Equivalent class <j, i>εZ×Z/K corresponds to the symbol at codeword j+[i div n]d, location i mod n. If <j, i>εZ×Z/K is already in canonical representation form (i.e., (j, i) is the canonical representative with 0≦i<n), then it corresponds to the symbol at codeword j, location i. As may be seen, there are a number of ways to refer to a given codeword symbol. For example, location i of codeword j, and location i−n of codeword j+d, refer to the same codeword symbol. Since g is a group isomorphism, then for any (x, y)εZ, g⁻¹(x+y)=g⁻¹(x)+g⁻¹(y). Also, for any integer m, g(<m, −[mn div d]>)=mn−[mn div d]d=mn mod d. As a result, g⁻¹(mn mod d)=<m, −[mn div d]>.

Now, [a, b] denotes a closed interval in Z, between a and b (i.e., [a, b]={kεZ: a≦k≦b}), and it represents a burst event of length b−a+1 symbols at the output of an interleaver. The composition of the set g⁻¹([a, b]) is evaluated, to determine codeword/symbol relationships at the input to the interleaver. Referring now to the instance where a burst length b−a+1 is a multiple of interleaver depth d (i.e., [a, b]=[a, a+kd−1] for some positive integer k), assume n−[mn div d]−1>k>[mn div d]+1.

$$\begin{matrix}Let [ a , b ] = {{⋃}_{p = 0}}^{d - 1} \{ a + p + qd : q = 0 , 1 , … , k - 1 \} , \\ then : {g}^{- 1} ( [ a , b ] ) = {{⋃}_{p = 0}}^{d - 1} {g}^{- 1} \{ a + p + qd : q = 0 , 1 , … , k - 1 \} \\ = {{⋃}_{p = 0}}^{d - 1} {g}^{- 1} ( a ) + {g}^{- 1} ( p ) + {g}^{- 1} ( qd ) : . \\ q = 0 , 1 , … , k - 1.\end{matrix} \qquad ( 6 )$$

Replacing index p with p=mn mod d, and using the fact that as p ranges through 0, 1, . . . , d−1, the substituted index m=pn⁻¹ mod d also ranges through the same set, then:

$$\begin{matrix}{g}^{- 1} ( [ a , b ] ) = {{⋃}_{m = 0}}^{d - 1} {g}^{- 1} ( a ) + {g}^{- 1} ( mn mod d ) + {g}^{- 1} ( qd ) : \\ q = 0 , 1 , … , k - 1.\end{matrix} \qquad ( 7 )$$

Let <j, i> be the canonical representation of g⁻¹(a). Then g⁻¹(a)=<j, i>. Since g⁻¹(mn mod d)=<m, −[mn div d]> and g⁻¹(qd)=<0, q>, then:

$$\begin{matrix}{g}^{- 1} ( [ a , b ] ) = {{⋃}_{m = 0}}^{d - 1} < j , i > + < m , - [ mn div d ] > + < 0 , q > : \\ q = 0 , 1 , … , k - 1 \} \\ = {{⋃}_{m = 0}}^{d - 1} {S}_{m} ; \\ where {S}_{m} = \{ < j + m , i + q - [ mn div d ] > : \\ q = 0 , 1 , … , k - 1 \} \\ = \{ < j + m , x > : x ∈ [ i - [ mn div d ] , \\ i + k - 1 - [ mn div d ] ] \} .\end{matrix} \qquad ( 8 )$$

Now, for each m=0, 1, . . . , d−1, the interval Iₘ falls into one of the following three categories:
Category 1: Iₘ=Gₘ∪Hₘ, where Gₘ⊂[0, n−1], and Hₘ⊂[n, ∞);
Category 2: Iₘ⊂[0, n−1]; or
Category 3: Iₘ=Eₘ∪Fₘ, where Eₘ⊂(−∞, 0), and Fₘ⊂[0, n −1];
   depending on whether m<m₁, m₁≦m≦m₂, or m>m₂, respectively—where m₁ and m₂ (0≦m₁<m₂≦d−1) are thresholds dividing the d values of m into the 3 categories.

If m₁=0, then category 1 is empty. If m₂=d−1, then category 3 is empty. However, the condition k>[n div d]+1 ensures that categories 1 and 3 cannot both be empty—and the condition n−[n div d]−1>k ensures that category 2 is never empty.

For 0<m<m₁, Sₘ={<j+m, x>: xεGₘ}∪{<j+m, x>: xεHₘ}—which can be written in canonical representation as Sₘ={<j+m, x>: xεGₘ}∪{<j+m+d, x>: xεHₘ−n}, where Hₘ−n={x−n: xεHₘ}. As a result, the following codewords may be determined: i) j,j+1, . . . ,j+m₁−1; and ii) j+d,j+d+1, . . . ,j+d+m₁−1.

For m₁≦m≦m₂, Sₘ={<j+m, x>: xεIₘ}; which is already in canonical representation. As a result, the following codeword may be determined: iii) j+m₁, j+m₁+1, . . . , j+m₂. For m>m₂, Sₘ={<j+m, x>: xεEₘ}∪{Sₘ={<j+m, x>: xεFₘ}—which can be written in canonical representation as Sₘ={<j+m−d, x>: xεEₘ+n}∪{<j+m, x>: xεFₘ−n}, where Eₘ+n={x+n: xεEₘ}. As a result, the following codewords may be determined: iv) j−d+m₂+1, j−d+m₂+2, . . . , j−1; and v) j+m₂+1, j+m₂+2, . . . , j+d−1. Thus, the overall set of consecutive codewords involved, obtained from combining the above results in the order iv), i), iii), v) and ii), is {j−d+m₂+1,j−d+m₂+2, . . . ,j+d+m₁−1}.

The above-described algorithm may also be verified by induction. Assuming that codeword i is decoded successfully, codeword i+1 needs to be successfully decoded. If codeword i is in a first group, where property (3) above applies, that property indicates that the next codeword i+1 will have no falsely erased symbols. This implies that the number of erasures s and errors t for this codeword satisfies: s+t=|Lᵢ₊₁|≦|Lₚ|=(R−h(n, d)−1)≦(R−[n div d]−1). The number of errors satisfies t=|Lᵢ₊₁|−|Lᵢ|≦[n div d]+1. As a result, s+2t≦R, and codeword i+1 may be decoded successfully.

If codeword i is in a second group, where property (4) above applies, that property indicates that for codeword i+1, the number of erasures s is (R−h(n, d)−1), and the number of errors t is either 0 or 1. As a result, s+2t≦(R−h(n, d)−1)≦R, and codeword i+1 may be decoded successfully.

If codeword i is in a third group, where property (5) above applies, that property indicates that for codeword i+1, the number of errors t is 0, and the number of erasures s is—at most—(R−h(n, d)−1). Once again, s+2t≦(R−h(n, d)−1)≦R, and codeword i+1 may be decoded successfully. In particular, codeword m+1 (i.e., the codeword that follows the final codeword affected by a burst error) may be decoded successfully. As a result, the forecasting algorithm terminates successfully.

For a codeword in each of the three groups discussed above, the number of errors and erasures in a subsequent codeword are summarized in Table 3, below.

TABLE 3

| | Group Number for Current Codeword | | |
|---|---|---|---|
| | 1 | 2 | 3 |
| Number of Erasures | | (R − h(n, | ≦(R − |
| s in Next Codeword | | d) − 1) | h(n, d) − 1) |
| Number of Errors t in | ≦[n div d] + 1 | ≦1 | 0 |
| Next Codeword | | | |
| s + t in Next Codeword | ≦R − [n div d] − 1 | | |
| s + 2t in Next Codeword | ≦R | ≦R | ≦R |
| False Erasures in | None | Possible | Possible |
| Next Codeword | | | |

As previously noted in reference to Table 1, consecutive codewords do not necessarily occupy consecutive columns in that table. In general, for a code length n, and interleave depth d, the difference in columns is n mod d. This value is also the difference in departure time slots, at the output of the interleaver, between a symbol in a current codeword and its successor in a subsequent codeword. For ease of reference, this value (n mod d) is referred to as forecasting distance.

In certain applications, the erasure forecasting algorithm thus far presented may be optimally effective when the forecasting distance has a value of 1. In such instances, the total number of false erasures through an entire erasure forecasting and decoding process for a given burst event is 1. Generalizing for such cases, the total number of false erasures may be considered equal to the forecasting distance.

There may be certain instances when the forecasting distance −1, which reduces the effectiveness of the erasure forecasting algorithm thus far described. In such instances, forecasting effectiveness may be improved by erasing a successor as well as a symbol that precedes the successor in a codeword. This approach may be utilized to particular advantage when it yields an even value of (R−s) (i.e., the number of redundant symbols less the number of erasures). Since the number of correctable errors t≦[(R−s)/2], an odd value for (R−s) does not provide any additional benefit if a corresponding increased error detection capability is not utilized.

Under the scheme(s) described above, a falsely erased symbol only occurs—if at all—at a location immediately following a set of contiguous locations affected by a burst within a codeword. This property may be exploited to eliminate undesired or accidental false erasures—keeping in mind that when a burst event begins, a first codeword affected by the burst has errors located near its end. Understanding these points, false starts of an erasure forecasting process may be avoided. Furthermore, when a burst event ends, a codeword that is not affected by the burst (i.e., the codeword immediately following the final one affected by the burst) has—at most—one false erasure. If such a false erasure occurs, it occurs at the first location of the codeword.

Referring now to an illustrative example, certain aspects of the present invention as described above may be evaluated for an ADSL application where n approximately equals 200, d=64, and R=16. In such an application, this case [n div d]=3, and R−[n div d]−1=12. Thus, the algorithm described above can correct bursts of lengths up to 12×64 symbols—representing nearly a 50% enhancement over an error—only decoding technique.

As previously noted, the explanation and description thus far has been related to relatively limited illustrative embodiments, where an assumption is made that most or all data within some relatively large transmission unit transmitted during an impulse noise event is invalid. A more general application of the present invention—one that comprehends a more robust operation and range of operating conditions—is now described and illustrated.

The description above introduced an erasure forecasting algorithm that enhances impulse noise protection (INP) for an ADSL/VDSL communication system. The assumption—that all bytes affected by an impulse event are bad—may or may not always hold true, depending on the nature of a given impulse event. Comprehending this, the present invention expands upon that base erasure forecasting algorithm to address this possibility.

The present invention provides, in addition to the erasure forecasting algorithm discussed, an algorithm to identify—at the output of a de-interleaver—the exact codewords, and byte locations within those codewords, corresponding to bytes in a discrete multi-tone modulation (DMT) frame—at the input to a de-interleaver. This result of such a frame-to-bytes translation algorithm may then be used as a basis for an erasure forecasting algorithm—one that corrects impulses affecting two consecutive DMT frames. Thus, according to the present invention, erasure forecasting may be cooperatively coupled with erasure decoding to provide an INP of two DMT frames. The forecasting algorithm may be extended in accordance with the present invention—if desired or necessary—to higher values of INP, with some additional processing overhead and complexity.

For each DMT frame, the erasure forecasting algorithm marks locations within the first several codewords affected by the frame. A determination of the occurrence of an impulse event is then made based upon the total number of erroneous bytes discovered by RS decoder, as compared with the total number of affected bytes within the set of codewords. If an impulse event is determined to have occurred, then all remaining bytes in subsequent codewords affected by the impulse are erased.

The present invention provides an algorithm to identify, at the output of a de-interleaver, the exact codewords and byte locations within those codewords corresponding to bytes in a DMT frame at the input to the de-interleaver. For purposes of explanation and illustration, assume that: n is the RS codeword length; d is the depth of interleaving; and the number of bytes in a DMT frame always exceeds both n and d.

Referring now to FIG. 2, diagram 200 depicts the composition and relation of several data transmission units. Diagram 200 comprises an upper level 202 and a lower level 204. Upper level 202 depicts a sequence of DMT frames as received at the input of a de-interleaver. Lower level 204 depicts a sequence of codewords as output from the de-interleaver. Level 202 comprises a sequence of frames 206, 208, and 212-214. Frame 206 represents a DMT frame (0), frame 208 represents frame (1), frame 210 represents frame (j−1), frame 212 represents frame (j), and frame 214 represents frame (j+1). Level 204 comprises a sequence of codewords 216-224. Codeword 216 represents codeword (0), codeword 218 represents codeword (1), codeword 222 represents codeword (i), codeword 224 represents codeword (i+1), and codeword 224 represents codeword (i+2).

Several bytes 226-230 are depicted throughout levels 202 and 204. Byte 226 represents the first byte—byte (0)—of frame (0). Bytes 228 and 230 correspond to the last byte—byte (n−1)—of codeword i. Level 204 further depicts a timeslots 232 and 234. Timeslot 234 represents timeslot (0), where the first byte—byte (0)—of codeword (0) occurs. Timeslot 232 represents timeslot (−(n−1)(d−1)).

For purposes of explanation and illustration, consider how frame 212 (frame (j )) affects codewords 216-224. In each timeslot, a byte is input into the de-interleaver, and a byte is output from the de-interleaver. As shown in FIG. 2, the timeslot 234 when byte (0) of codeword (0) exits the de-interleaver is labeled timeslot (0). This same byte enters the de-interleaver as byte 226 is in timeslot 232 (i.e., timeslot −(n−1)(d−1)). The delay of this byte through the de-interleaver is (n−1)(d−1). If I denotes any time slot, then I=Ix(n)+Iy, where 0≦Iy<n. If I is initialized to −(n−1)(d−1) at the beginning of frame (0), then Ix represents the index of a codeword exiting the de-interleaver, and Iy represents the location of a byte within that codeword at time slot I.

The last byte 230 (byte (n−1)) of a codeword experiences zero delay through the de-interleaver, as illustrated for the case of codeword i. In diagram 200, the first codeword affected by frame (j) is codeword i. If J denotes the timeslot when the first byte of frame (j) enters the de-interleaver, and J=Jx(n)+Jy, where 0≦Jy<n, then Jx=i, and the value Jy may be used to precisely compute affected locations within codeword i. Since consecutive bytes within codeword i at the output of the de-interleaver are separated, d bytes apart, at the input to the de-interleaver, the number of locations in codeword i affected by frame (j) is [(n−1−Jy) div d]+1. If K=n−1−Jy=Kx(d)+Ky, where 0≦Ky≦d, then Kx+1 is the number of locations in codeword i affected by frame (j), and the interval [n−Kx−1, n−1] represents the set of locations affected. Similarly, the number of locations in codeword i+1 affected by frame (j) is [(2n−1−Jy) div d]+1. If n=nx(d)+ny, where 0≦ny<d, then a new pair of (Kx, Ky) can be updated for codeword i+1 using assignments of: a) Kx=Kx+nx+carry, where carry=1 if Ky+ny≧d, or 0 otherwise; and b) Ky=(Ky+ny) mod d.

Now, updated Kx+1 represents the number of locations in codeword i+1 affected by frame (j), and the interval [n−Kx−1, n−1] represents the set of locations affected. Assignments a) and b) as listed above are used to update the pair (Kx, Ky) for codeword i+2 in FIG. 2. Codeword i+2 is the first codeword affected by frame (j+1). Jx and Jy are updated appropriately for frame (j+1). Specifically, J denotes the time slot when the first byte of frame (j+1) enters the de-interleaver, and J=Jx(n)+Jy, where 0≦Jy<n. If n−1−Jy=Lx(d)+Ly, where 0≦Ly <d, then Lx+1 represents the number of locations affected by frame (j+1), and interval [n−Lx−1, n−1] represents the set of locations affected. The set of locations in codeword i+2 affected by frame (j) may also be computed. The number of such locations is Kx−Lx, and the set is represented by the interval [n−Kx−1, n−Lx−2].

The locations affected by frame (j) in subsequent codewords (e.g., codeword i+3, i+4) may be identified by updating (Kx, Ky) and (Lx, Ly) once per codeword, using assignments a) and b) from above, and the following assignments: c) Lx=Lx +nx+carry, where carry=1 if Ly+ny≧d, or 0 otherwise; and d) Ly=(Ly+ny) mod d. The set of affected locations in the codeword corresponding to the current update is represented by the interval [max{n−Kx−1, 0}, n−Lx−2]. When n−Lx−2 becomes negative (i.e., Lx≧n−1), then the corresponding codeword is no longer affected by frame (j).

Given all of this, an algorithm for translating a DMT frame, at the input of the de-interleaver, to byte locations within codewords at the output of the de-interleaver, may now be provided. The present invention provides an algorithm that determines codewords and byte locations affected by frame (i). That algorithm is presented below in pseudo-code format:

```
Subroutine A: (* update Kx and Ky *)
    If Ky + ny ≧ d, then carry = 1
    Else carry = 0
    Kx = Kx + nx + carry
    Ky = (Ky + ny) mod d
Subroutine B: (* Update Lx and Ly *)
    If Ly + ny ≧ d, then carry = 1
    Else carry = 0
    Lx = Lx + nx + carry
    Ly = (Ly + ny) mod d
Subroutine C: (* Compute Kx and Ky *)
    Write K = n − 1 − Jy = Kx(d) + Ky, where 0 ≦ Ky < d
    Kx = [(n − 1 − Jy) div d]
    Ky = (n − 1 − Jy) mod d
Subroutine D: (* Compute Lx and Ly *)
    Write L = n − 1 − Jy = Lx(d) + Ly, where 0 ≦ Ly < d
    Lx = [(n − 1 − Jy) div d]
    Ly = (n − 1 − Jy) mod d
Subroutine E: (* Update Jx and Jy *)
    Write current frame size F as F = Fx(n) + Fy, where 0 ≦ Fy < n
    Fx = F div n
    Fy = F mod n
    If Jy + Fy ≧n, then carry = 1
    Else carry = 0
    Jx = Jx + Fx + carry
    Jy = (Jy + Fy) mod n
(* Initialization *)
J = −(n − 1)(d − 1) = Jx(n) + Jy, where 0 ≦ Jy < n
Jx = [(d − 1) div n] − d + 1
Jy = (d − 1) mod n
Frame Index = 0
Codeword Index Ix = 0
Write code length n as n = nx(d) + ny, where 0 ≦ ny < d
nx = n div d
ny = n mod d
(* Compute Jx, Jy for frame (j) *)
While (Frame Index ≠j) {
    Update Jx, Jy using Subroutine E;
    Increment Frame Index;
  }
(* Frame Index now equals j *)
(* Compute Kx, Ky for codeword Jx *)
While (Ix ≠ Jx)
    Increment Ix; (* Codeword Index now equals Jx for frame (j) *)
    Compute Kx, Ky using Subroutine C
(* Compute Jx, Jy for frame (j + 1) *)
Update Jx, Jy using Subroutine E
Increment Frame Index (* Frame Index now equals j + 1 *)
(* Output result and update Kx, Ky *)
While (Ix ≠Jx) {
  Output interval [n − Kx − 1, n − 1] as set of Kx + 1 locations
  in codeword Ix affected by frame (j)
  Increment Codeword Index Ix
  Update Kx, Ky using Subroutine A
  }
(* Codeword Index now equals updated Jx for frame (j + 1) *)
Compute Lx, Ly using Subroutine D
(* Output result and update Kx, Ky, Lx, Ly *)
While (Lx ≦n − 2) {
  Output interval [max {n − Kx − 1, 0}, n − Lx − 2] as set
  of min {Kx − Lx, n − Lx − 1 } locations in codeword Ix
  affected by frame (j)
  Increment Codeword Index Ix
  Update Kx, Ky using Subroutine A
  Update Lx, Ly using Subroutine B
  }.
```

The operations or processing required to implement this algorithm may be performed or disposed the output of a de-interleaver (i.e., local to the Reed-Solomon decoder), assuming that DMT frame sizes can be computed algorithmically. Furthermore, this algorithm may be modified to compute codewords and byte locations affected by a sequence of k frames, starting at frame (j). For these embodiments:

```
    (* Compute Jx, Jy for frame (j + 1) *)
    Update Jx, Jy using Subroutine E
    Increment Frame Index (* Frame Index now equals j + 1 *) ;
should be replaced with:
    (* Compute Jx, Jy for frame (j + k) *)
    While (Frame Index ≠j + k) {
        Update Jx, Jy using Subroutine E
        Increment Frame Index
        }.
```

The case k=2 is of particular interest, since we are dealing with INP=2 DMT frames. In certain embodiments of the present invention, an erasure forecasting algorithm for correction of impulses that affect two consecutive DMT frames (INP=2 DMT frames) is provided. That algorithm may, optionally, be extended to provide higher values of INP in accordance with the present invention.

Utilizing Subroutines A-E described above, codewords and byte locations affected by every DMT frame are continuously computed. For each DMT frame, the number of bytes affected thereby is relatively small for a first-affected codeword; and then increases gradually for subsequent affected codewords, before stabilizing and then decreasing. Affected byte locations are marked, and a cumulative count of such locations is maintained. This cumulative count C represents a total number of bytes, up to the current codeword, affected by an impulse of 2 frames long that starts at a frame currently being processed.

Another cumulative count E is maintained, which represents a total number of erroneous bytes discovered by a RS decoder, up to the current codeword, in the set of locations affected by an impulse which starts at a current frame. The ratio of E/C provides an error metric that may be compared against a user or designer selectable threshold T, to determine whether the affected bytes in an upcoming codeword should be erased. For each DMT frame, codewords are continually processed, and corresponding E/C ratios—which represent the percentage of actual erroneous bytes among the set of locations affected by the current frame—are computed. This ratio E/C indicates a likelihood of an impulse occurrence, and may be used to determine whether affected bytes in the next codeword should be erased.

This step is repeated until after a first codeword affected by the next frame has been processed—at which point a decision must be made. Based on the most current E/C ratio, the system determines whether all remaining bytes in subsequent codewords affected by the impulse (starting at the current frame) should be erased. If the decision is yes, these bytes are erased in subsequent codewords, and decoded accordingly, before processing merges back into the main flow. If the decision is no, the next frame is evaluated—becoming the current frame—and the process is repeated.

In order to successfully supplement the algorithm already described in detail, and additional subroutine may be added as follows:

```
Subroutine F: (* Erase as appropriate, perform RS decode,
update E and C *)
  Mark interval [n − Kx − 1, n −1] as the set of Kx + 1 locations in
  current codeword Ix affected by impulse which starts at
  current frame
  (* T is the selectable threshold for comparison against ratio E/C *)
  If (E > CT), then erase bytes in interval [n − Kx − 1, n − 1] in
  codeword Ix
  Decode codeword Ix
  E = E + # of erroneous bytes in interval [n − Kx − 1, n − 1] in
  codeword Ix
  C = C + Kx + 1;
```

and the algorithm is provided as follows:

```
(* Initialization *)
J = −(n − 1)(d − 1) = Jx(n) + Jy, where 0 ≦ Jy < n
Jx = [(d − 1) div n] − d + 1
Jy = (d − 1) mod n
Frame Index = 0
Codeword Index Ix = 0
Write code length n as n = nx(d) + ny, where 0 ≦ ny < d
nx = n div d
ny = n mod d
(* Increment Frame Index until Jx ≧0 *)
While (Jx < 0) {
  Update Jx, Jy using Subroutine E
  Increment Frame Index
  }
(* Compute Kx, Ky for codeword Jx *)
Stepmark 200
While (Ix ≠Jx)
    Increment Ix; (* Codeword Index now equals Jx *)
    Compute Kx, Ky using Subroutine C
    Set E = 0 and C = 0
(* Compute Jx, Jy for next frame *)
Stepmark 100
Update Jx, Jy using Subroutine E
Increment Frame Index
(* Process codewords *)
While (Ix ≠Jx) {
  Use Subroutine F to erase as appropriate, perform RS decode,
  and update E and C
  Increment Codeword Index Ix;
  Update Kx, Ky using Subroutine A;
  }
(* Codeword Index now equals Jx *)
(* Process another codeword and make branching decision *)
Use Subroutine F to erase as appropriate, perform RS decode,
and update E and C
If (E ≦CT) {
  Compute Kx, Ky using Subroutine C
  Set E = # of erroneous bytes in interval [n − Kx − 1, n − 1] in
  codeword Ix
  Set C = Kx + 1
  Increment Codeword Index Ix;
  Update Kx, Ky using Subroutine A
  Go to Stepmark 100
  }
Else
  (* Erase all remaining bytes affected by current impulse, RS
  decode accordingly *)
  Update Jx, Jy using Subroutine E
  Increment Frame Index
  Compute Lx, Ly using Subroutine D
  Increment Codeword Index Ix
  Update Kx, Ky using Subroutine A
  While (Ix ≠Jx) {
    Erase the Kx + 1 locations in interval [n − Kx − 1, n − 1] in current
    codeword Ix
    Decode codeword Ix
    Increment Codeword Index Ix
    Update Kx, Ky using Subroutine A
    }
  While (Lx ≦n − 2) {
    Erase min{Kx − Lx, n − Lx − 1} locations in interval
    [max{n − Kx − 1, 0}, n − x − 2] in current codeword Ix
    Decode codeword Ix
    Increment Codeword Index Ix
    Update Kx, Ky using Subroutine A
    Update Lx, Ly using Subroutine B
    }
(* Increment Frame Index until Jx ≧Ix *)
While (Jx<Ix) {
  Update Jx, Jy using Subroutine E
  Increment Frame Index
  }
```

Go to Stepmark 200.

The description thus far has assumed that DMT frame boundaries always fall on byte boundaries. In a number of embodiments, this assumption may not hold true. In such embodiments, the present invention follows the convention that a DMT frame boundary is always rounded down to the nearest byte boundary coming before that frame boundary. With this convention, a 2-frame long impulse event will sometimes carry over to a third frame—affecting that frame's first byte. In such instances, the system as thus far presented may be adjusted by replacing Subroutine E with:

```
Subroutine E‘: (* Update Jx and Jy *)
    Adjust current frame size from F to F+1
    Write F + 1 = Fx(n) + Fy, 0 ≦ Fy < n
    Fx = [(F+1) div n]
    Fy = (F+1) mod n
    If Jy + Fy ≧n, then carry = 1
    Else carry = 0
    Jx = Jx + Fx + carry
    Jy = (Jy + Fy) mod n.
```

Once again, the operations or processing required to implement this algorithm may be performed or disposed the output of a de-interleaver (i.e., local to the Reed-Solomon decoder), assuming that DMT frame sizes can be computed algorithmically.

The decision point for determining an occurrence of an impulse event may be selected based on a number of factors. A large enough value of C should be accumulated such that comparison of ratio E/C against threshold T gives a statistically reliable indicator of an impulse occurrence. This may be balanced by a need to have reasonable processing and implementation overhead or complexity. Before the decision point is reached, the value of C is relatively small—leading to a less reliable erasure indication. As a result, an impulse event might potentially be missed, and bytes in a current codeword affected by the impulse mistakenly not erased. Fortunately, however, this corresponds to the case where the number of bytes affected in the current codeword is small, and may be decoded successfully even when the bytes are not erased.

Depending upon certain system design or implementation requirements, the present invention comprehends reformatting the algorithm described above to facilitate a hardwired implementation. For example, computation of Jx can effectively be accomplished by looking for changes in a Frame Parity signal (i.e., LSB of Frame Index) when sampled at codeword boundaries. Also, computation of K=n−1−Jy may be implemented by a down-counter for H=n−1−Iy, instead of an up-counter for Iy. In this manner, the value of a down-counter sampled at DMT frame boundary will directly give the desired result for K=n−1−Jy. Furthermore, a down-counter for H can be implemented using a pair of counters (Hx, Hy), where H=Hx(d)+Hy, with 0≦Hy<d. The values of these pair of counters, sampled at DMT frame boundary, will directly yield the desired result for Kx=[(n−1−Jy) div d] and Ky=(n−1−Jy) mod d.

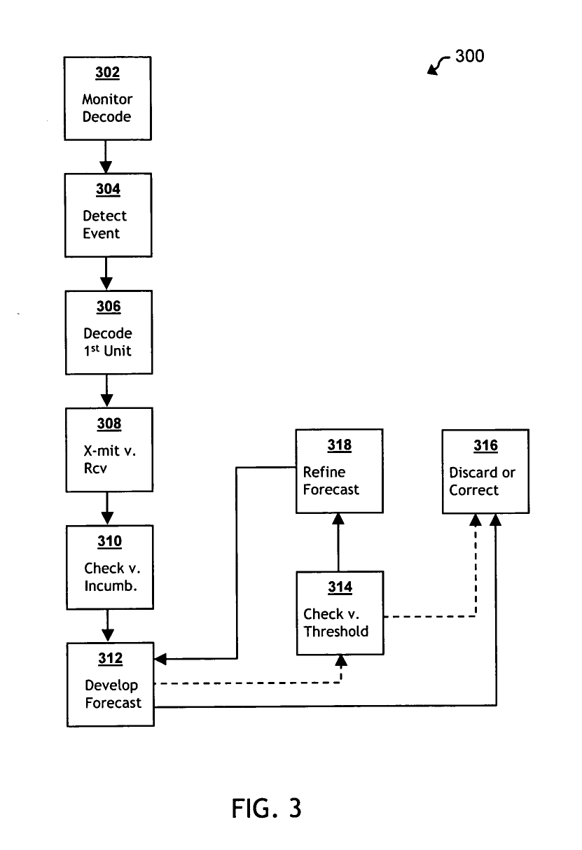

Thus, the present invention provides a highly adaptable erasure forecasting and decoding system that may be operationally implemented in a number of ways. Referring now FIG. 3, a high-level erasure forecasting system 300 in accordance with the present invention is depicted. At some point during the operation of a communications system within which it is implemented, system 300 monitors data decoding 302 on the receiver side. Once an impulse noise event is detected 304, the incumbent decoding scheme (e.g., RS decoding) is used 306 to decode the first transmission unit affected by the event. Once that first transmission unit has been successfully decoded, an evaluation 308 of differences between the transmitted version of the transmission unit and the received version is performed. The extent and relative location of any erasures and, by process of elimination, any errors within the first affected transmission unit is compared 310 with the known spreading or randomization characteristics (e.g., RS, DMT) of the communication system to develop a model or forecast 312 of error/erasure locations in subsequent transmission units. The difference between erasures or errors, and their relative locations, is comprehended by the forecast. System 300 may then check to determine if cumulative data on errors/erasures has met or exceeded a desired threshold 314. If this threshold check indicates some sufficient volume of errors/erasures, some portion—or all—of the transmission unit affected may be corrected or discarded 316. Finally, whether the threshold is met or not, the results of this process may be appended to the existing data 318, and used to refine or reiterate the development of the model or forecast.

Thus, the system of the present invention provides an erasure forecasting system that comprehends both data errors and data erasures due to impulse noise and other noise events. The system of the present invention provides constructs that analyze received data transmissions to determine if incoming transmission errors are data erasures and, if so, to forecast the location of such erasures. The system of the present invention further comprehends and provides the ability to evaluate the validity of data experiencing impulse noise. Rather than completely discard all data transmitted during an impulse noise event, the present invention provides a metric by which the extent of valid or invalid data transmitted during the event may be characterized. That metric may then be compared to some desired threshold, above which or below which different data processing assumptions may be made for convenience and efficiency.

In all embodiments of the present invention, the constituent constructs, routines, functions or components may be implemented in a wide variety of ways- comprising various suitable software and hardware constructs, and combinations of both. For example, the algorithms and routines described herein may be implemented as separate code segments, grouped together in functional segments, or incorporated as part of a larger integrated code segment. Those code segments may comprise software operating on a host computer system, or routines operating on a digital signal processor. As alluded to above, certain functions or operations may be provided in a hardwired configuration. Certain functional components may be implemented as a combination of hardware and software. All of these variations, and all other similar variations and combinations, are comprehended by the present invention. All such embodiments may be employed to provide the benefits of the present invention.

The embodiments and examples set forth herein are therefore presented to best explain the present invention and its practical application, and to thereby enable those skilled in the art to make and utilize the invention. However, those skilled in the art will recognize that the foregoing description and examples have been presented for the purpose of illustration and example only. The teachings and principles of the present invention are applicable to DSL, ADSL, VDSL, and other broadband and digital communications technologies. The description as set forth herein is therefore not intended to be exhaustive or to limit the invention to the precise form disclosed. As stated throughout, many modifications and variations are possible in light of the above teaching without departing from the spirit and scope of the following claims.

1. A method of correcting erasure errors occurring within a DSL-based communication system, the method comprising the steps of:
providing an incumbent pre-transmission data structuring scheme;
providing a corresponding incumbent post-transmission data de-structuring scheme;
providing a monitoring construct that monitors data de-structuring and identifies an impulse noise event;
providing an evaluation construct that determines a first data transmission unit affected by the impulse noise event;
providing a forecasting construct that evaluates the first data transmission unit, using known characteristics of the incumbent pre-transmission data structuring scheme, to identify a location of an erasure error within the first data transmission unit and, based on that evaluation, generates a forecast of location of erasure error(s) within subsequent data transmission unit(s); and
cooperatively processing the forecast with incumbent post-transmission data de-structuring scheme to optimize an error correction construct.

2. The method of claim 1, wherein the DSL-based communication system comprises an ADSL communication system.

3. The method of claim 1, wherein the DSL-based communication system comprises an VDSL communication system.

4. The method of claim 1, wherein the steps of providing an incumbent pre-transmission data structuring scheme and a corresponding incumbent post-transmission data de-structuring scheme further comprise providing a Reed-Solomon encoding and decoding scheme.

5. The method of claim 1, wherein the steps of providing an incumbent pre-transmission data structuring scheme and a corresponding incumbent post-transmission data de-structuring scheme further comprise providing a discrete multi-tone modulation and demodulation scheme.

6. The method of claim 1, wherein the step of providing an evaluation construct that determines a first data transmission unit affected by the impulse noise event further comprises providing an evaluation construct that determines a first codeword affected by the impulse noise event.

7. The method of claim 1, wherein the step of providing an evaluation construct that determines a first data transmission unit affected by the impulse noise event further comprises providing an evaluation construct that determines a first timeslot affected by the impulse noise event.

8. The method of claim 1, wherein the step of providing an evaluation construct that determines a first data transmission unit affected by the impulse noise event further comprises providing an evaluation construct that determines a first byte affected by the impulse noise event.

9. The method of claim 1, wherein the step of providing a forecasting construct that evaluates the first data transmission unit, using known characteristics of the incumbent pre-transmission data structuring scheme, to identify a location of an erasure error within the first data transmission unit further comprises providing a forecasting construct that evaluates the first data transmission unit, using known characteristics of the incumbent pre-transmission data structuring scheme, to identify a timeslot of an erasure error within the first data transmission unit.

10. The method of claim 1, wherein the step of providing a forecasting construct that generates a forecast of location of erasure error(s) within subsequent data transmission unit(s) further comprises providing a forecasting construct that generates a forecast of location of erasure error(s) within subsequent data transmission unit(s) responsive to an error metric.

11. The method of claim 10, wherein the forecasting construct that generates a forecast of location of erasure error(s) within subsequent data transmission unit(s) responsive to an error metric generates the forecast based upon an assumption of contiguous error(s) if the metric is above a desired threshold, or upon an assumption of non-contiguous error(s) if the metric is below the desired threshold.

12. A system for mitigating impulse noise effects in a digital data transmission, the system comprising:
an encoding construct that encodes digital data received from a data input;
a structuring construct that permutes data received from the encoding construct into data transmission units in a deterministic manner;
a transmission channel over which data transmission units, received from the structuring construct, are transmitted;
a de-structuring construct that inversely permutes data transmission units received from the transmission channel according to the deterministic manner;
a decoding construct that decodes data received from the de-structuring construct;
a monitoring construct that monitors data decoding and identifies an impulse noise event;
an evaluation construct that decodes, using the decoding construct, a first data transmission unit affected by the impulse noise event;
a forecasting construct that evaluates the decoded first data transmission unit, using known characteristics of the deterministic manner, to identify a location of an erasure error within the decoded first data transmission unit and forecasts a location of erasure error(s) within subsequent decoded data transmission unit(s); wherein
the forecast is cooperatively processed with the decoding construct to optimize an error correction construct.

13. The system of claim 12, wherein the encoding construct further comprises a Reed-Solomon encoding construct.

14. The system of claim 12, wherein the decoding construct further comprises a Reed-Solomon decoding construct.

15. The system of claim 12, wherein the structuring construct further comprises a discrete multi-tone modulation construct.

16. The system of claim 12, wherein the de-structuring construct further comprises a discrete multi-tone demodulation construct.

17. The system of claim 12, wherein the first data transmission unit further comprises a first codeword.

18. The system of claim 12, wherein the first data transmission unit further comprises a first byte.

19. The system of claim 12, wherein the forecasting construct generates a forecast of location of erasure error(s) within subsequent data transmission unit(s) responsive to an error metric.

20. The system of claim 12, wherein the forecasting construct generates a forecast of location of erasure error(s) within subsequent data transmission unit(s) responsive to an error metric, based upon an assumption of contiguous error(s) if the metric is above a desired threshold, or upon an assumption of non-contiguous error(s) if the metric is below the desired threshold.
